(19) United States
(12) Patent Application Publication
(10) Pub. No.: US 2022/0199338 A1
(43) Pub. Date: Jun. 23, 2022

(54) KEY STRUCTURE AND ELASTIC CONDUCTION ELEMENT THEREOF

(71) Applicant: Primax Electronics Ltd., Taipei (TW)

(72) Inventors: Chia-Wei Chang, Taipei (TW); Chin-Sung Pan, Taipei (TW); Lei-Lung Tsai, Taipei (TW)

(21) Appl. No.: 17/164,936

(22) Filed: Feb. 2, 2021

(30) Foreign Application Priority Data
Dec. 18, 2020 (TW) 109144918

(51) Int. Cl. H01H 13/7065; H01H 13/85

(52) U.S. Cl. CPC H01H 13/7065; H01H 13/85; H01H 2221/05; H01H 2217/01; H01H 2221/044; H01H 2215/03

(57) ABSTRACT

A key structure includes a membrane switch, a keycap and an elastic conduction element. The keycap is located over the membrane switch. The elastic conduction element is arranged between the keycap and the membrane switch. The elastic conduction element includes a supporting cover and a conduction post. The conduction post is connected with the supporting cover and disposed within an accommodation space of the supporting cover. The conduction post includes a first contacting part, a second contacting part and a concave part. While the keycap is moved downwardly relative to the membrane switch, the supporting cover is compressed by the keycap and the conduction post is correspondingly moved downwardly. Consequently, the first contacting part and the second contacting part are contacted with the membrane switch, and a suction force between the concave part and the membrane switch is generated.

### FIELD OF THE INVENTION

The present invention relates to an input device, and more particularly to a key structure and an elastic conduction element thereof.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The input devices of the common electronic devices include for example mouse devices, keyboard devices, trackball devices, or the like. Via the keyboard device, texts or symbols can be inputted into the computer system directly. As a consequence, most users and most manufacturers of input devices pay much attention to the development of keyboard devices.

Generally, a keyboard device comprises plural key structures. Each key structure comprises a keycap, a scissors-type connecting member, a membrane circuit board and a supporting plate. These components are stacked on each other sequentially. In case that the keyboard device is a luminous keyboard device, the keyboard device is equipped with a backlight module under the supporting plate.

Moreover, a membrane switch is installed on the membrane circuit board, and an elastic conduction element is arranged between the keycap and the membrane circuit board. The scissors-type connecting member is connected between the keycap and the supporting plate. Moreover, the scissors-type connecting member comprises a first frame and a second frame. The second frame is pivotally coupled to the first frame. Consequently, the first frame and the second frame can be swung relative to each other. While the keycap of any key structure is depressed and moved downwardly relative to the supporting plate, the first frame and the second frame of the scissors-type connecting member are switched from an open-scissors state to a stacked state. Moreover, as the keycap is moved downwardly to compress the elastic conduction element, the corresponding membrane switch is pushed and triggered by the elastic conduction element. Consequently, the keyboard device generates a corresponding key signal.

When the keycap of the key structure is no longer depressed, the keycap is moved upwardly relative to the supporting plate in response to an elastic force of the elastic conduction element. Meanwhile, the first frame and the second frame are switched from the stacked state to the open-scissors state again, and the keycap is returned to its original position.

In some situations, regardless of whether a general word processing task or an e-sports playing task is performed, it is necessary to implement the key inputting action on the keyboard device at a faster speed. That is, regardless of whether a middle region or a periphery region of the key structure is depressed, it is preferred that the key signal is effectively triggered to provide the real-time command input efficacy. Consequently, in addition to the rigidity of the key structure itself, the internal elastic conduction element plays a very important role. However, the conventional keyboard device still has some drawbacks. For example, according to the conventional design, the elastic conduction element of each key structure is pressed to the bottom in order to push and trigger the corresponding membrane switch. Under this circumstance, the time point of triggering the key signal is later, and a higher pressing force is required to press the corner of the key structure to trigger the key signal.

Therefore, there is a need of providing an improved key structure and an improved elastic conduction element in order to overcome the drawbacks of the conventional technologies.

### SUMMARY OF THE INVENTION

An object of the present invention provides a key structure. An elastic conduction element of the key structure is specially designed to shorten the travel distance of the triggering the membrane switch. While the keycap is moved upwardly and restored, a sound is generated. Consequently, the action of depressing the key structure generates a clear clicking feel.

Another object of the present invention provides an elastic conduction element. The elastic conduction element is specially designed to shorten the travel distance of the triggering the membrane switch. While the keycap is moved upwardly and restored, a sound is generated. Consequently, the action of depressing the key structure generates a clear clicking feel.

The other objects and advantages of the present invention will be understood from the disclosed technical features.

In accordance with an aspect of the present invention, a key structure is provided. The key structure includes a membrane switch, a keycap and an elastic conduction element. The keycap is located over the membrane switch. The keycap is movable upwardly or downwardly relative to the membrane switch. The elastic conduction element is arranged between the keycap and the membrane switch. The elastic conduction element includes a supporting cover and a conduction post. The supporting cover includes an accommodation space. The conduction post is connected with the supporting cover and disposed within the accommodation space. The conduction post includes a first contacting part, a second contacting part and a concave part. The concave part is arranged between the first contacting part and the second contacting part. The second contacting part is arranged around the concave part. The concave part is arranged around the first contacting part. While the keycap is moved downwardly relative to the membrane switch, the supporting cover is compressed by the keycap and the conduction post is correspondingly moved downwardly. While the conduction post is moved downwardly, the first contacting part and the second contacting part are contacted with the membrane switch and a suction force between the concave part and the membrane switch is generated.

In an embodiment, the first contacting part of the conduction post has a first contact surface facing the membrane switch, the second contacting part of the conduction post has a second contact surface facing the membrane switch, and the first contacting part is extended in a direction toward the membrane switch. The first contact surface and the second contact surface are located at different horizontal planes. While the keycap is moved downwardly relative to the membrane switch, the first contact surface of the first contacting part is firstly contacted with the membrane switch. As the keycap is continuously moved downwardly relative to the membrane switch, the second contact surface of the second contacting part is contacted with the membrane switch.

In an embodiment, the second contact surface of the second contacting part is a ring-shaped flat surface.

In an embodiment, the first contacting part of the conduction post has a first contact surface facing the membrane switch, the second contacting part of the conduction post has a second contact surface facing the membrane switch, and the first contact surface and the second contact surface are located at a same horizontal plane. While the keycap is moved downwardly relative to the membrane switch, the first contact surface of the first contacting part and the second contact surface of the second contacting part are simultaneously contacted with the membrane switch.

In an embodiment, the second contact surface of the second contacting part is a ring-shaped flat surface.

In an embodiment, an orthographic projection pattern of the concave part of the conduction post on the membrane switch is a ring-shaped pattern.

In an embodiment, while the keycap is moved upwardly relative to the membrane switch in response to an elastic restoring force of the elastic conduction element, the conduction post is moved upwardly with the supporting cover. As the conduction post is moved upwardly, the first contacting part and the second contacting part are moved in a direction away from the membrane switch. Consequently, the suction force between the concave part and the membrane switch is released and a sound is generated.

In an embodiment, the key structure further includes a membrane circuit board, and the membrane switch is installed on the membrane circuit board.

In an embodiment, the key structure further includes a supporting plate, and the supporting plate is located under the membrane circuit board.

In an embodiment, the supporting cover further includes a top wall and a lateral wall. The lateral wall is extended downwardly from a periphery region of the top wall. The top wall is contacted with the keycap. The lateral wall is contacted with the membrane circuit board. The accommodation space is defined by the top wall and the lateral wall. The conduction post is connected with the top wall.

In accordance with another aspect of the present invention, an elastic conduction element is provided. The elastic conduction element is arranged between a membrane switch and a keycap of a key structure. The elastic conduction element includes a supporting cover and a conduction post. The supporting cover includes an accommodation space. The conduction post is connected with the supporting cover and disposed within the accommodation space. The conduction post includes a first contacting part, a second contacting part and a concave part. The concave part is arranged between the first contacting part and the second contacting part. The second contacting part is arranged around the concave part. The concave part is arranged around the first contacting part. While the keycap is moved downwardly relative to the membrane switch, the supporting cover is compressed by the keycap and the conduction post is correspondingly moved downwardly. While the conduction post is moved downwardly, the first contacting part and the second contacting part are contacted with the membrane switch and a suction force between the concave part and the membrane switch is generated.

From the above descriptions, the present invention provides the key structure. The conduction post of the elastic conduction element comprises the first contacting part, the second contacting part and the concave part. The concave part is arranged between the first contacting part and the second contacting part. The second contacting part is arranged around the concave part. The concave part is arranged around the first contacting part. While the keycap is moved downwardly relative to the membrane switch, the first contacting part and the second contacting part of the conduction post are contacted with the membrane switch. Consequently, it can be ensured that the membrane switch is effectively triggered after the keycap is depressed. In addition, the travel distance of triggering the membrane switch can be effectively shortened. Even if the corner of the keycap is accidentally depressed by the user, the membrane switch can be effectively and reliably triggered without the need of applying additional pressing force. Moreover, after the concave part of the conduction post is contacted with the membrane switch, the concave part and the membrane switch can be attracted by each other in response to a suction force. While the keycap is moved upwardly relative to the membrane switch in response to an elastic restoring force of the elastic conduction element, the suction force between the concave part and the membrane switch is released and a sound is generated. Consequently, the action of depressing the key structure generates a clear clicking feel.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic cross-sectional view illustrating a key structure according to an embodiment of the present invention;

FIG. 2 is a schematic cross-sectional view illustrating the key structure as shown in FIG. 1 and in a depressed state;

FIG. 3 is a schematic enlarged view illustrating the region A of the key structure as shown in FIG. 1;

FIG. 4 is a schematic bottom view illustrating the elastic conduction element of the key structure as shown in FIG. 1;

FIG. 5 is a schematic cross-sectional view illustrating a key structure according to another embodiment of the present invention; and

FIG. 6 is a schematic enlarged view illustrating the region B of the key structure as shown in FIG. 5.

### DETAILED DESCRIPTION OF THE PREFERRED EMBODIMENT

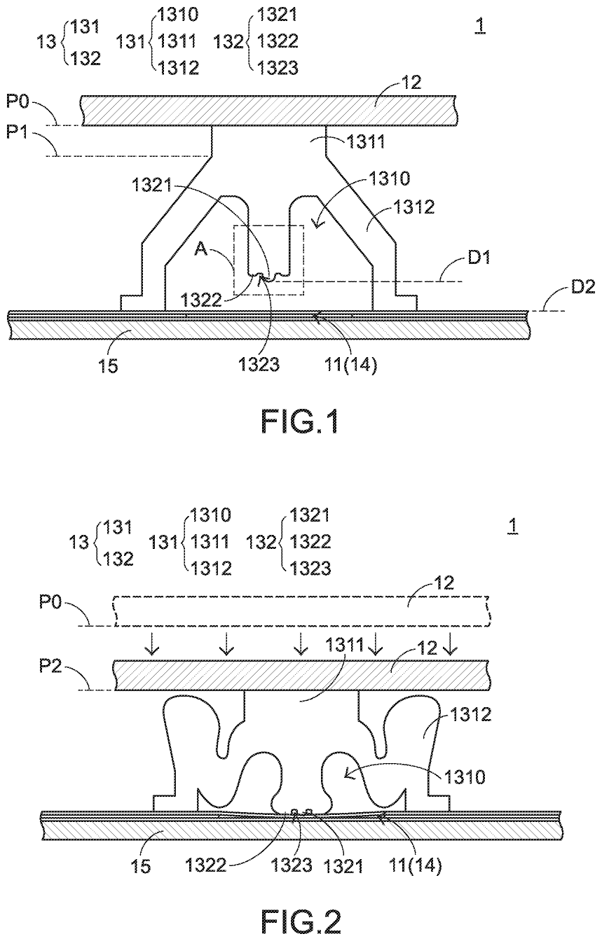

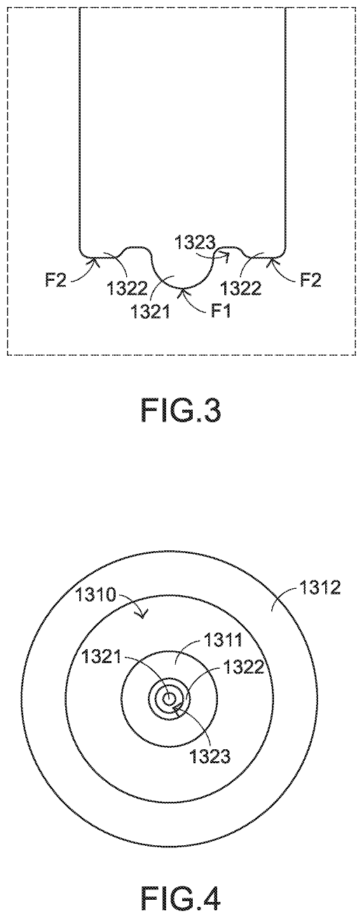

Please refer to FIGS. 1, 2, 3 and 4. FIG. 1 is a schematic cross-sectional view illustrating a key structure according to an embodiment of the present invention. FIG. 2 is a schematic cross-sectional view illustrating the key structure as shown in FIG. 1 and in a depressed state. FIG. 3 is a schematic enlarged view illustrating the region A of the key structure as shown in FIG. 1. FIG. 4 is a schematic bottom view illustrating the elastic conduction element of the key structure as shown in FIG. 1.

Please refer to FIGS. 1 and 2. In an embodiment, the key structure 1 comprises a membrane switch 11, a keycap 12 and an elastic conduction element 13. The keycap 12 is located over the membrane switch 11. The keycap 12 is movable upwardly or downwardly relative to the membrane switch 11. The elastic conduction element 13 is arranged between the keycap 12 and the membrane switch 11. The key structures 1 of the keyboard device can be classified into some types, e.g., ordinary keys, numeric keys and function keys. When one of the key structures 1 is depressed by the user's finger, the keyboard device generates a corresponding key signal to a computer, and thus the computer executes a corresponding function. For example, when an ordinary key is depressed, a corresponding English letter or symbol is inputted into the computer. When a numeric key is depressed, a corresponding number is inputted into the computer. In addition, the function keys (F1˜F12) can be programmed to provide various quick access functions. Alternatively, the key further includes a Space key, a Shift key or any other similar multiple key with the larger area and length.

Please refer to FIGS. 1, 2, 3 and 4. In this embodiment, the elastic conduction element 13 comprises a supporting cover 131 and a conduction post 132. The supporting cover 131 comprises an accommodation space 1310. The conduction post 132 is connected with the supporting cover 131 and disposed within the accommodation space 1310. The conduction post 132 comprises a first contacting part 1321, a second contacting part 1322 and a concave part 1323. The concave part 1323 is arranged between the first contacting part 1321 and the second contacting part 1322. The second contacting part 1322 is arranged around the concave part 1323. The concave part 1323 is arranged around the first contacting part 1321. While the keycap 12 is moved downwardly relative to the membrane switch 11, the supporting cover 131 of the elastic conduction element 13 is compressed by the keycap 12 and the conduction post 132 is correspondingly moved downwardly. In this way, the first contacting part 1321 and the second contacting part 1322 of the conduction post 132 are contacted with the membrane switch 11. Moreover, a suction force is generated between the concave part 1323 of the conduction post 132 and the membrane switch 11.

The key structure 1 and the elastic conduction element 13 of the key structure 1 will be described in more details as follows.

Please refer to FIGS. 1 and 2 again. In an embodiment, the key structure 1 further comprises a membrane circuit board 14 and a supporting plate 15. The membrane switch 11 is installed on the membrane circuit board 14. The supporting plate 15 is located under the membrane circuit board 14. Preferably but not exclusively, the supporting plate 15 is made of a metallic material. In fact, the key structure 1 further comprises a scissors-type connecting member. The scissors-type connecting member is connected between the keycap 12 and the supporting plate 15. The keycap 12 is movable upwardly or downwardly relative to the membrane circuit board 14 through the scissors-type connecting member. For clearly illustrating the structure and the operation of the elastic conduction element 13, the scissors-type connecting member is not shown in FIGS. 1 and 2.

As shown in FIGS. 1, 2 and 4, the supporting cover 131 of the elastic conduction element 13 further comprises a top wall 1311 and a lateral wall 1312. The lateral wall 1312 is extended downwardly from the periphery region of the top wall 1311. In an embodiment, the top wall 1311 of the supporting cover 131 is contacted with the keycap 12, and the lateral wall 1312 of the supporting cover 131 is contacted with the membrane circuit board 14. In addition, the accommodation space 1310 is defined by the top wall 1311 and the lateral wall 1312 of the supporting cover 131. In an embodiment, the conduction post 132 of the elastic conduction element 13 is connected with the top wall 1311 of the supporting cover 131 and disposed within the accommodation space 1310 of the supporting cover 131. That is, the conduction post 132 is protruded from the top wall 1311 of the supporting cover 131 in a direction toward the membrane switch 11, and the conduction post 132 is disposed within the accommodation space 1310.

Please refer to FIGS. 1, 2, 3 and 4 again. The first contacting part 1321 of the conduction post 132 has a first contact surface F1 that faces the membrane switch 11. The second contacting part 1322 of the conduction post 132 has a second contact surface F2 that faces the membrane switch 11. The first contacting part 1321 of the conduction post 132 is extended in the direction toward the membrane switch 11. Consequently, the first contacting part 1321 is closer to the membrane switch 11 than the second contacting part 1322, and the first contact surface F1 of the first contacting part 1321 and the second contact surface F2 of the second contacting part 1322 are located at different horizontal planes. That is, the extension length of the first contacting part 1321 is larger than the extension length of the second contacting part 1322. Preferably but not exclusively, the second contact surface F2 of the second contacting part 1322 is a ring-shaped flat surface. As mentioned above, the concave part 1323 is arranged between the first contacting part 1321 and the second contacting part 1322. Preferably but not exclusively, the orthographic projection pattern of the concave part 1323 on the membrane switch 11 is a ring-shaped pattern.

Please refer to FIGS. 1 and 2 again. As mentioned above, the first contacting part 1321 of the conduction post 132 is extended in the direction toward the membrane switch 11. Before the keycap 12 is depressed, the keycap 12 is in a position P0. While the keycap 12 is moved downwardly relative to the membrane switch 11 from the position P0 to a position P1, the first contacting part 1321 is moved downwardly from a position D1 to a position D2. Consequently, the first contact surface F1 of the first contacting part 1321 is firstly contacted with the membrane switch 11 (see FIG. 1). As the keycap 12 is continuously moved downwardly relative to the membrane switch 11 from the position P1 to a position P2, the second contact surface F2 of the second contacting part 1322 is contacted with the membrane switch 11 (see FIG. 2). Due to the structural design, the first contacting part 121 and the second contacting part 1322 of the conduction post 132 are sequentially contacted with the membrane switch 11. Consequently, it can be ensured that the membrane switch 11 is effectively triggered after the keycap 12 is depressed. In addition, the travel distance of triggering the membrane switch 11 can be effectively shortened. Even if the corner of the keycap 12 is accidentally depressed by the user, the membrane switch 11 can be effectively and reliably triggered without the need of applying additional pressing force.

Please refer to FIGS. 1 and 2 again. While the keycap 12 is moved downwardly relative to the membrane switch 11 from the position P0 to the position P2, the conduction post 132 is compressed and subjected to deformation. At the same time, the air inside the concave part 1323 of the conduction post 132 is pushed out. Since the air pressure inside the concave part 1323 is lower than the air pressure of the ambient environment, the concave part 1323 and the membrane switch 11 can be attracted by each other in response to the suction force.

Moreover, the keycap 12 can be moved upwardly relative to the membrane switch 11 in response to an elastic restoring force of the elastic conduction element 13. While the keycap 12 is moved upwardly relative to the membrane switch 11 from the position P2 to the position P0, the conduction post 132 is moved upwardly with the supporting cover 131 of the elastic conduction element 13. Consequently, the first contacting part 121 and the second contacting part 1322 are moved in the direction away from the membrane switch 11. At the time when the suction force between the concave part 1323 and the membrane switch 11 is released, a sound is generated. Especially, the inner space of the concave part 1323 has the efficacy of amplifying the sound. Due to this structural design, every action of depressing the key structure 1 generates a clear clicking feel in response to the sound generation.

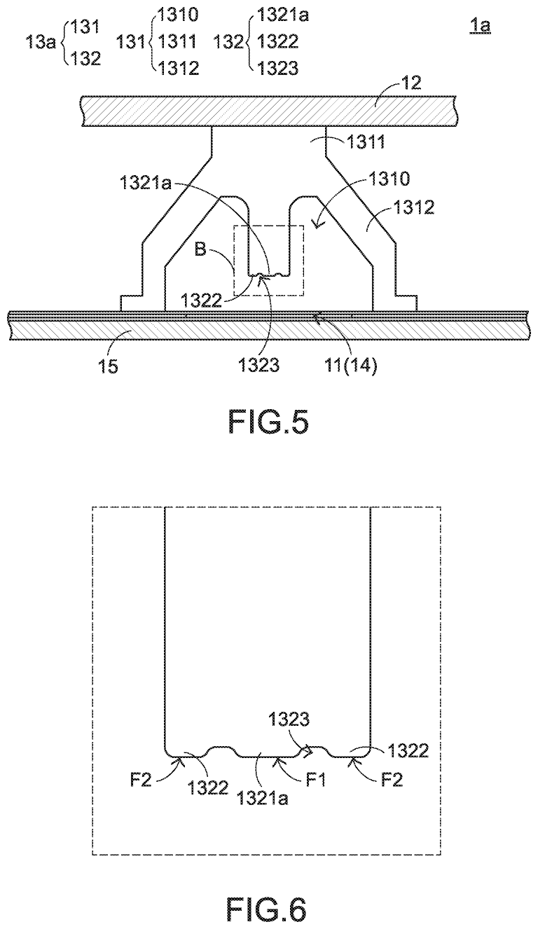

Please refer to FIGS. 5 and 6. FIG. 5 is a schematic cross-sectional view illustrating a key structure according to another embodiment of the present invention. FIG. 6 is a schematic enlarged view illustrating the region B of the key structure as shown in FIG. 5. In comparison with the key structure 1 as shown in FIGS. 1 to 4, the elastic conduction element 13a of the key structure 1a of this embodiment is distinguished. In the conduction post 132 of the elastic conduction element 13a, the first contact surface F1 of the first contacting part 1321a and the second contact surface F2 of the second contacting part 1322a are located at the same horizontal plane. While the keycap 12 is moved downwardly relative to the membrane switch 11, the first contact surface F1 of the first contacting part 1321a and the second contact surface F2 of the second contacting part 1322a are simultaneously contacted with the membrane switch 11. The other components of the key structure 1a and the connecting relationships between these components are similar to those of the key structure 1 as shown in FIGS. 1 to 4, and not redundantly described herein. Moreover, the key structure 1a of this embodiment also has the functions like the key structure 1. For example, it can be ensured that the membrane switch 11 is effectively triggered after the keycap 12 is depressed. In addition, the travel distance of triggering the membrane switch 11 can be effectively shortened. Even if the corner of the keycap 12 is accidentally depressed by the user, the membrane switch 11 can be effectively and reliably triggered without the need of applying additional pressing force. Moreover, every action of depressing the key structure 1a generates a clear clicking feel because of the sound.

From the above descriptions, the present invention provides the key structure. The conduction post of the elastic conduction element comprises the first contacting part, the second contacting part and the concave part. The concave part is arranged between the first contacting part and the second contacting part. The second contacting part is arranged around the concave part. The concave part is arranged around the first contacting part. While the keycap is moved downwardly relative to the membrane switch, the first contacting part and the second contacting part of the conduction post are contacted with the membrane switch. Consequently, it can be ensured that the membrane switch is effectively triggered after the keycap is depressed. In addition, the travel distance of triggering the membrane switch can be effectively shortened. Even if the corner of the keycap is accidentally depressed by the user, the membrane switch can be effectively and reliably triggered without the need of applying additional pressing force. Moreover, after the concave part of the conduction post is contacted with the membrane switch, the concave part and the membrane switch can be attracted by each other in response to a suction force. While the keycap is moved upwardly relative to the membrane switch in response to an elastic restoring force of the elastic conduction element, the suction force between the concave part and the membrane switch is released and a sound is generated. Consequently, the action of depressing the key structure generates a clear clicking feel.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A key structure, comprising:
a membrane switch;
a keycap located over the membrane switch, wherein the keycap is movable upwardly or downwardly relative to the membrane switch; and
an elastic conduction element arranged between the keycap and the membrane switch, and comprising a supporting cover and a single conduction post, wherein the supporting cover comprises an accommodation space, the conduction post is connected with the supporting cover and disposed within the accommodation space, and the conduction post comprises a first contacting part, a second contacting part and a concave part, wherein the concave part is arranged between the first contacting part and the second contacting part, the second contacting part is arranged around the concave part, and the concave part is arranged around the first contacting part,
wherein while the keycap is moved downwardly relative to the membrane switch, the supporting cover is compressed by the keycap and the conduction post is correspondingly moved downwardly, wherein while the conduction post is moved downwardly, the first contacting part and the second contacting part are contacted with the membrane switch and a suction force between the concave part and the membrane switch is generated.

2. The key structure according to claim 1, wherein the first contacting part of the conduction post has a first contact surface facing the membrane switch, the second contacting part of the conduction post has a second contact surface facing the membrane switch, and the first contacting part is extended in a direction toward the membrane switch, so that the first contact surface and the second contact surface are located at different horizontal planes, wherein while the keycap is moved downwardly relative to the membrane switch, the first contact surface of the first contacting part is firstly contacted with the membrane switch, wherein as the keycap is continuously moved downwardly relative to the membrane switch, the second contact surface of the second contacting part is contacted with the membrane switch.

3. The key structure according to claim 2, wherein the second contact surface of the second contacting part is a ring-shaped flat surface.

4. The key structure according to claim 1, wherein the first contacting part of the conduction post has a first contact surface facing the membrane switch, the second contacting part of the conduction post has a second contact surface facing the membrane switch, and the first contact surface and the second contact surface are located at a same horizontal plane, wherein while the keycap is moved downwardly relative to the membrane switch, the first contact surface of the first contacting part and the second contact surface of the second contacting part are simultaneously contacted with the membrane switch.

5. The key structure according to claim 4, wherein the second contact surface of the second contacting part is a ring-shaped flat surface.

6. The key structure according to claim 1, wherein an orthographic projection pattern of the concave part of the conduction post on the membrane switch is a ring-shaped pattern.

7. The key structure according to claim 1, wherein while the keycap is moved upwardly relative to the membrane switch in response to an elastic restoring force of the elastic conduction element, the conduction post is moved upwardly with the supporting cover, wherein as the conduction post is moved upwardly, the first contacting part and the second contacting part are moved in a direction away from the membrane switch, so that the suction force between the concave part and the membrane switch is released and a sound is generated.

8. The key structure according to claim 1, wherein the key structure further comprises a membrane circuit board, and the membrane switch is installed on the membrane circuit board.

9. The key structure according to claim 8, wherein the key structure further comprises a supporting plate, and the supporting plate is located under the membrane circuit board.

10. The key structure according to claim 8, wherein the supporting cover further comprises a top wall and a lateral wall, wherein the lateral wall is extended downwardly from a periphery region of the top wall, the top wall is contacted with the keycap, the lateral wall is contacted with the membrane circuit board, the accommodation space is defined by the top wall and the lateral wall, and the conduction post is connected with the top wall.

11. An elastic conduction element arranged between a membrane switch and a keycap of a key structure, the elastic conduction element comprising:
a supporting cover comprising an accommodation space; and
a single conduction post connected with the supporting cover and disposed within the accommodation space, and comprising a first contacting part, a second contacting part and a concave part, wherein the concave part is arranged between the first contacting part and the second contacting part, the second contacting part is arranged around the concave part, and the concave part is arranged around the first contacting part,
wherein while the keycap is moved downwardly relative to the membrane switch, the supporting cover is compressed by the keycap and the conduction post is correspondingly moved downwardly, wherein while the conduction post is moved downwardly, the first contacting part and the second contacting part are contacted with the membrane switch and a suction force between the concave part and the membrane switch is generated.
